(19) United States
(12) Patent Application Publication
(10) Pub. No.: US 2015/0296577 A1
(43) Pub. Date: Oct. 15, 2015

(54) Ceiling Fan Device with LED Lamp

(71) Applicant: Chin-Li Chen, Dong Guan City (CN)

(72) Inventor: Chin-Li Chen, Dong Guan City (CN)

(21) Appl. No.: 14/248,379

(22) Filed: Apr. 9, 2014

(51) Int. Cl. H05B 33/08

(52) U.S. Cl. CPC H05B 33/0815; H05B 33/0845; H05B 33/0857

(57) ABSTRACT

A ceiling fan device includes a ceiling fan provided with a light emitting diode (LED) lamp, and an actuating and dimming integrator including an actuating and dimming integration circuit which includes an actuating circuit module, a regulating constant current circuit module, and a main control chip. The regulating constant current circuit module includes a first photovoltaic coupler, a digital/analogue (D/A) converter circuit, a comparator chip, and a sampling resistor. The main control chip outputs a pulse width modulation (PWM) which is transmitted through the first photovoltaic coupler to the D/A converter circuit to produce a steady direct-current basis voltage which is supplied to the comparator chip to function as a standard of a current sampling judgment. The comparator chip samples and compares a current of the sampling resistor with the direct-current basis voltage.

### BACKGROUND OF THE INVENTION

1. Field of the Invention

The present invention relates to a ceiling fan device and, more particularly, to a ceiling fan device with a light emitting diode (LED) lamp.

2. Description of the Related Art

A conventional ceiling fan device in accordance with the prior art shown in FIGS. 1 and 2 comprises a ceiling fan “a”, an actuator “b” connected with the ceiling fan “a”, and a dimmer “c” connected with the actuator “b”. The ceiling fan “a” is provided with a light emitting diode (LED) lamp. The dimmer “c” includes a dimming circuit “d” connected with the LED lamp to proceed a dimming action to the LED lamp by a triac so as to regulate the brightness of the LED lamp. Preferably, the dimmer “c” regulates the opening time of the LED lamp in a phase-cut manner so as to dim and regulate the brightness of the LED lamp. However, the actuator “b” and the dimmer “c” are operated independently and are not integrated so that the current of the actuator “b” is consumed for keeping operation of the dimmer “c”, thereby decreasing the working efficiency of the actuator “b”. In addition, the dimmer “c” dims and regulates the brightness of the LED lamp by a phase-cut operation which easily disturbs and interferes with the electric grid, so that the dimmer “c” is not operated stably.

### BRIEF SUMMARY OF THE INVENTION

In accordance with the present invention, there is provided a ceiling fan device comprising a ceiling fan, and an actuating and dimming integrator. The ceiling fan is provided with a light emitting diode (LED) lamp. The actuating and dimming integrator includes an actuating and dimming integration circuit. The actuating and dimming integration circuit includes an actuating circuit module, a regulating constant current circuit module, and a main control chip connected with the actuating circuit module and the regulating constant current circuit module. The regulating constant current circuit module includes a first photovoltaic coupler, a digital/analogue (D/A) converter circuit, a comparator chip, and a sampling resistor. The actuating and dimming integration circuit further includes a second photovoltaic coupler connected between the actuating circuit module and the comparator chip. The main control chip outputs a pulse width modulation (PWM) which is transmitted through the first photovoltaic coupler to the D/A converter circuit to produce a steady direct-current basis voltage which is supplied to the comparator chip to function as a standard of a current sampling judgment. The comparator chip samples and compares a current of the sampling resistor with the direct-current basis voltage.

According to the primary advantage of the present invention, the actuating and dimming integration circuit integrates the dimming and actuating actions of the LED lamp so that the LED lamp is directly actuated and dimmed without having to provide an independent dimming system.

According to another advantage of the present invention, the LED lamp is dimmed by regulation of a steady-state constant current instead of a conventional phase-cut dimming regulation.

According to a further advantage of the present invention, the current passing through the LED lamp is regulated by changing the basis voltage of the regulating constant current circuit module so as to stabilize and balance the LED lamp so that the LED lamp is worked stably in a steady manner.

According to a further advantage of the present invention, the brightness of the LED lamp is regulated by changing the basis voltage of the regulating constant current circuit module so that the brightness of the LED lamp is changed and adjusted easily and conveniently.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a conventional ceiling fan device in accordance with the prior art.

FIG. 2 is a circuit layout of the conventional ceiling fan device as shown in FIG. 1.

FIG. 3 is a perspective view of a ceiling fan device in accordance with the preferred embodiment of the present invention.

FIG. 4 is a circuit layout of the ceiling fan device as shown in FIG. 3.

FIG. 5 is an enlarged circuit layout of a regulating constant current circuit module of the ceiling fan device as shown in FIG. 4.

FIG. 6 is an enlarged circuit layout of an actuating circuit module of the ceiling fan device as shown in FIG. 4.

FIG. 7 is an enlarged circuit layout of the regulating constant current circuit module of the ceiling fan device as shown in FIG. 5, wherein the DC voltage functions as the sampling basis of the current of the actuating circuit module.

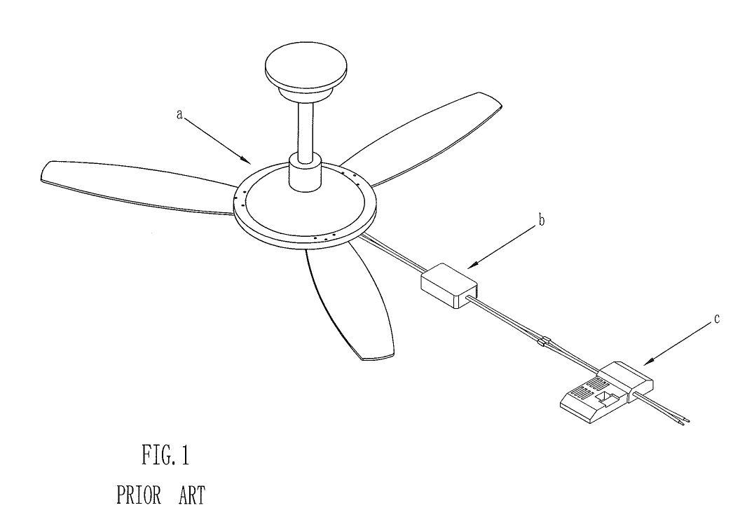

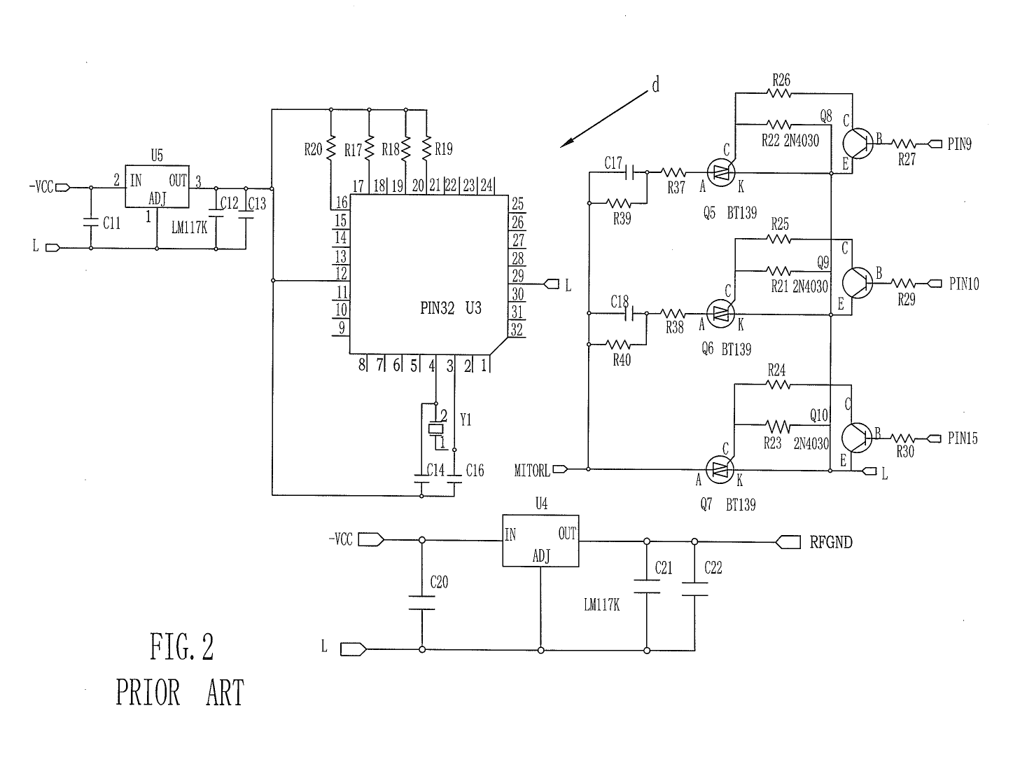

### DETAILED DESCRIPTION OF THE INVENTION

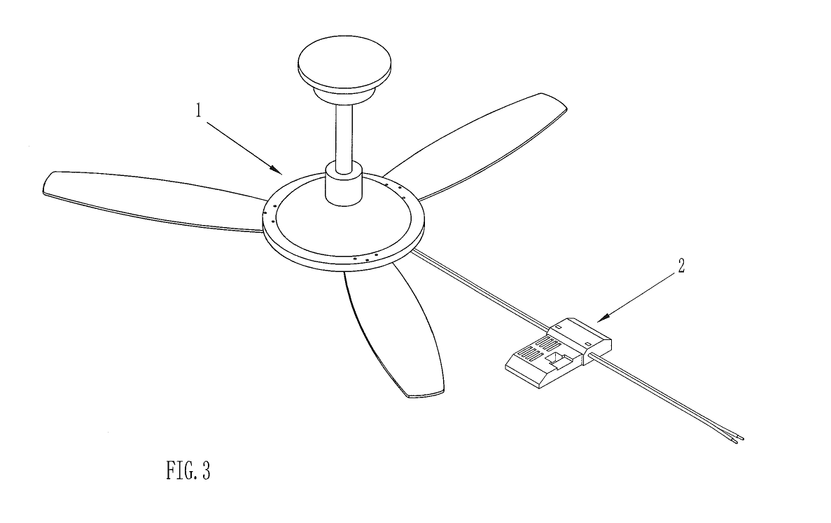

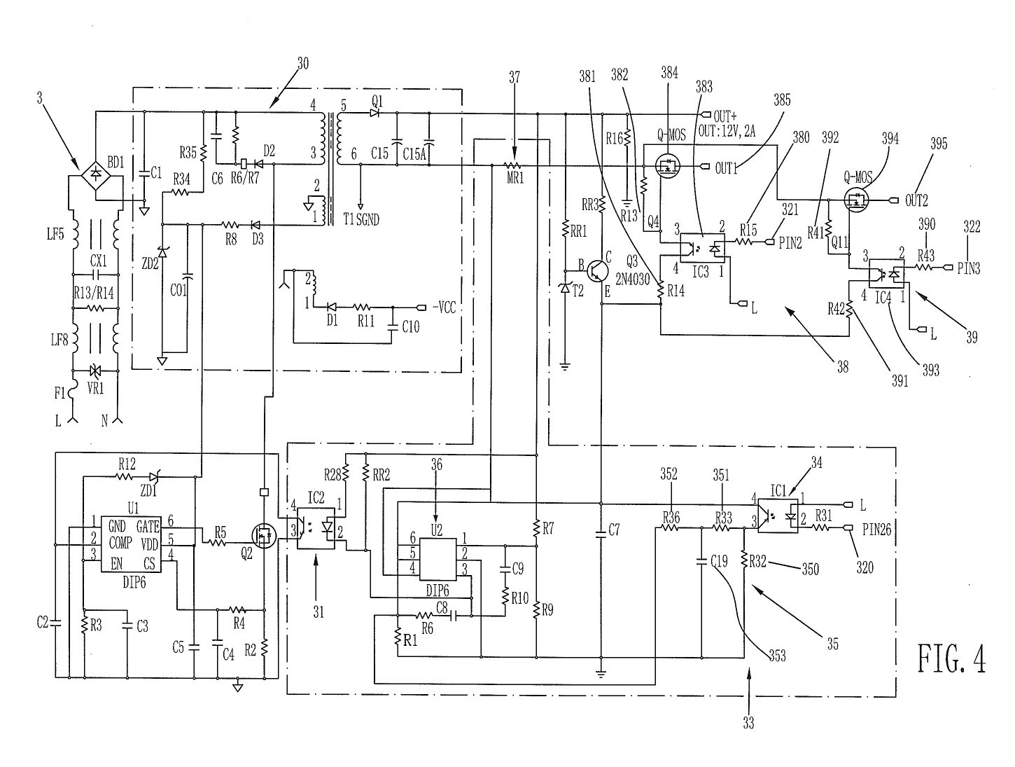

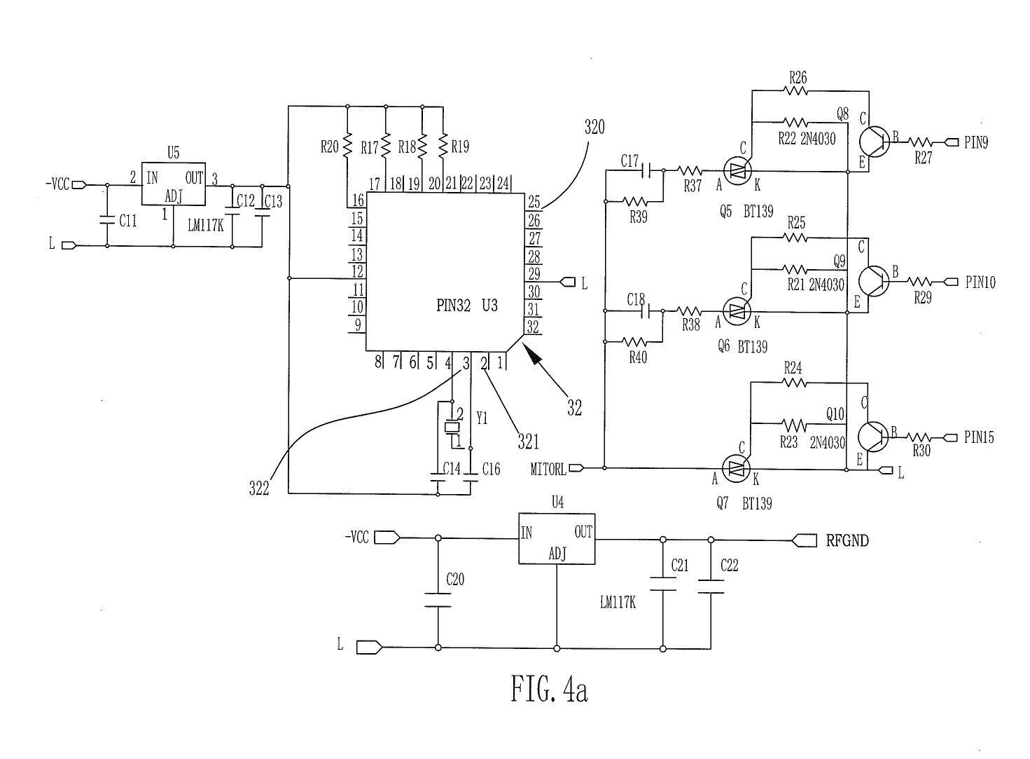

Referring to the drawings and initially to FIGS. 3 and 4, a ceiling fan device in accordance with the preferred embodiment of the present invention comprises a ceiling fan 1, and an actuating and dimming integrator 2.

The ceiling fan 1 is provided with a light emitting diode (LED) lamp.

The actuating and dimming integrator 2 is mounted on a bottom of the ceiling fan 1 and connected with the LED lamp of the ceiling fan 1. The actuating and dimming integrator 2 includes an actuating and dimming integration circuit 3.

The actuating and dimming integration circuit 3 includes an actuating circuit module 30, a regulating constant current circuit module 33, and a main control chip 32 connected with the actuating circuit module 30 and the regulating constant current circuit module 33.

The regulating constant current circuit module 33 includes a first photovoltaic coupler 34, a digital/analogue (D/A) converter circuit 35, a comparator chip 36, and a sampling resistor 37.

The first photovoltaic coupler 34 is connected with the main control chip 32 which has a terminal 320 connected to the first photovoltaic coupler 34.

The D/A converter circuit 35 is connected with the first photovoltaic coupler 34 and includes a first resistor 350, a second resistor 351, a third resistor 352 and a capacitor 353.

The comparator chip 36 is connected with the D/A converter circuit 35.

The sampling resistor 37 is connected with the comparator chip 36. The sampling resistor 37 is connected with the actuating circuit module 30 and the LED lamp serially so that the current passing through the LED lamp is equal to that passing through the sampling resistor 37.

The actuating and dimming integration circuit 3 further includes a second photovoltaic coupler 31 connected between the actuating circuit module 30 and the comparator chip 36.

In operation, referring to FIGS. 4-7 with reference to FIG. 3, the main control chip 32 proceeds a program decoding operation on a wireless signal to obtain an operational command, and the terminal 320 of the main control chip 32 outputs and emits a required pulse width modulation (PWM) which is separated and transmitted through the first photovoltaic coupler 34 to the D/A converter circuit 35 to produce a steady direct-current basis voltage which is supplied to the comparator chip 36 to function as a standard of a current sampling judgment. At this time, the direct-current basis voltage is directly proportional to the current passing through the sampling resistor 37. In addition, the sampling resistor 37 is connected with the LED lamp serially so that the current passing through the LED lamp is equal to that passing through the sampling resistor 37. In such a manner, the actuating and dimming integration circuit 3 integrates the dimming and actuating actions of the LED lamp so that the LED lamp is directly actuated and dimmed without having to provide an independent dimming system.

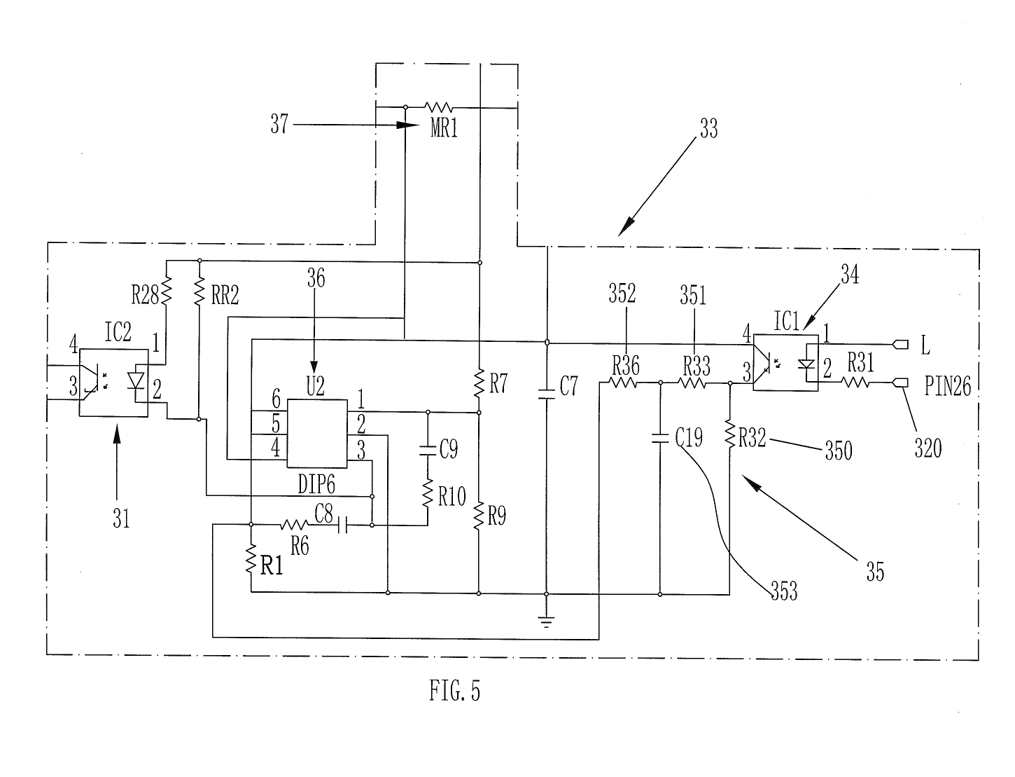

In addition, the comparator chip 36 samples and compares the current of the sampling resistor 37 with the direct-current basis voltage as shown in FIG. 5. If the current of the sampling resistor 37 is greater than the direct-current basis voltage, the second photovoltaic coupler 31 emits a current decreasing commander to the actuating circuit module 30 so as to decrease the current passing through the sampling resistor 37. If the current of the sampling resistor 37 is smaller than the direct-current basis voltage, the second photovoltaic coupler 31 emits a current increasing commander to the actuating circuit module 30 so as to increase the current passing through the sampling resistor 37. In such a manner, the current passing through the sampling resistor 37, that is, the current passing through the LED lamp, corresponds to the direct-current basis voltage, so that regulation of the direct-current basis voltage is equal to regulation of the sampling resistor 37. Thus, a steady-state constant current is supplied to the LED lamp when the direct-current basis voltage is kept at a constant condition. Therefore, the dimming manner of the LED lamp is operated by regulation of a steady-state constant current instead of a conventional phase-cut dimming regulation.

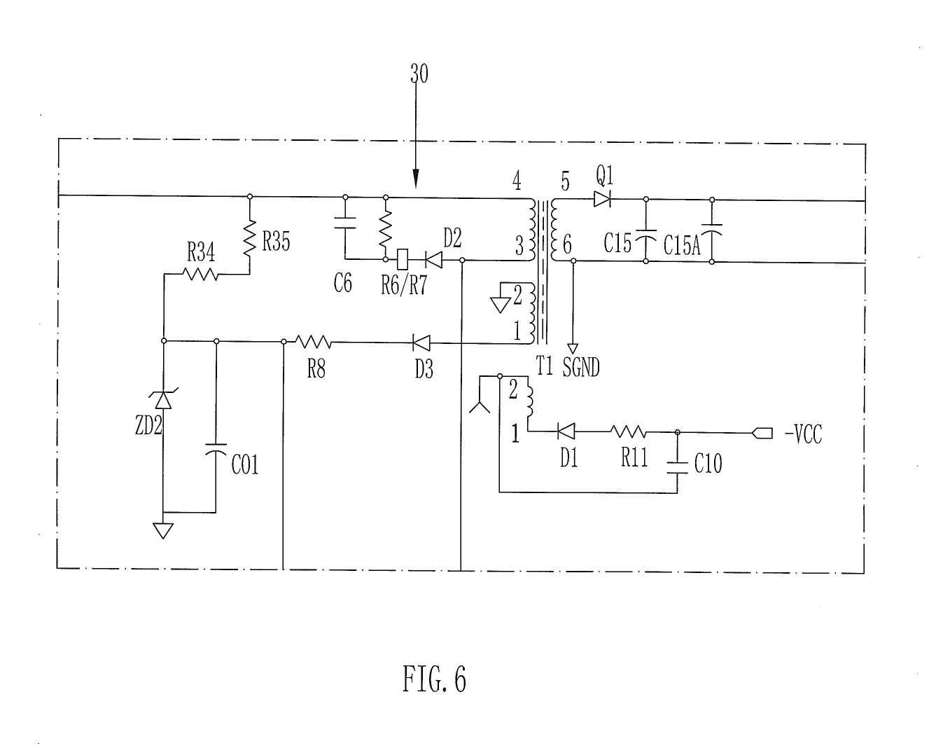

In addition, the LED lamp has a steady-state constant current with little current and photo fluctuation to enhance the working efficiency of the LED lamp so that the LED lamp has a greater working stability. Besides, the actuating circuit module 30 is highly efficiently stabilized by the little current and photo fluctuation as shown in FIG. 6.

In addition, the mark-space ratio (or duty cycle) of the PWM of the terminal 320 of the main control chip 32 is regulated to obtain the direct-current basis voltage which corresponds to the current of the LED lamp, which corresponds to the brightness of the LED lamp, so that the brightness of the LED lamp is changed and adjusted easily and conveniently by regulating the PWM of the terminal 320 of the main control chip 32.

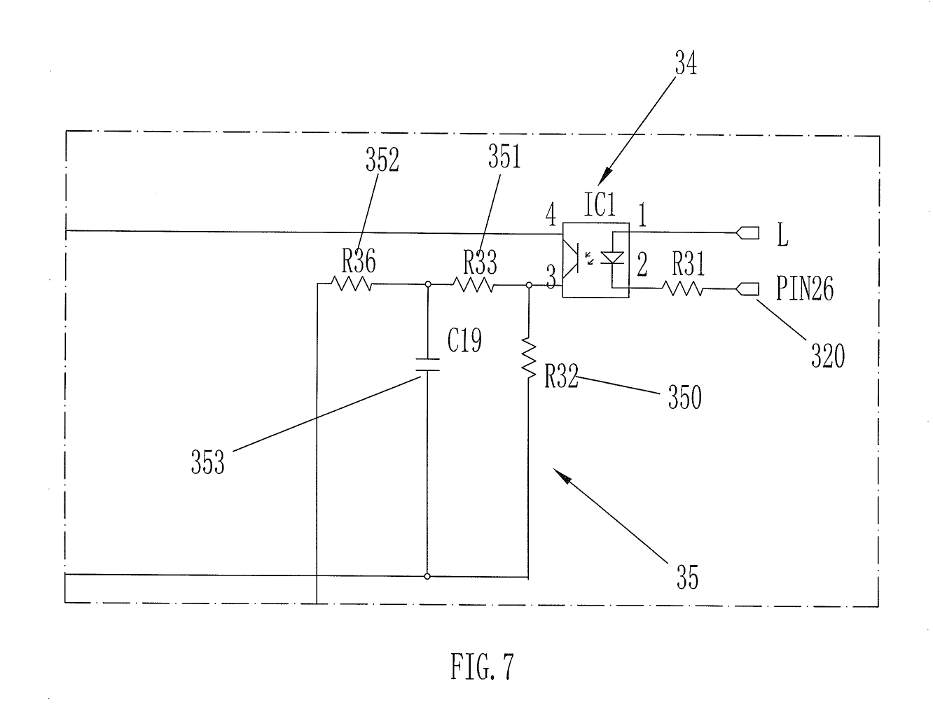

In conclusion, the actuating and dimming integration circuit 3 is primarily a micro controller unit (MCU) which includes a function module and an analogue module. The function module is used for processing finite digital signals. The MCU supplies a determined PWM according to the requirement. The MCU uses a digital output of a microprocessor to proceed a digital coding action on the level of an analogue signal. By using a calculator with high resolution, the mark-space ratio of the square wave is modulated to encode the level of an analogue signal. The PWM is still a digital signal. The full-amplitude direct-current power supply is all on or all off at any moment, so that the current or voltage is applied to an analogue load by a repeated impulse sequence of on or off. When the power supply is on, the direct-current power supply is applied to the load, and when the power supply is off, the direct-current power supply applied to the load is interrupted. When the bandwidth is enough, any analogue value can be used to encode the PWM, and then to convert the PWM into a direct-current (DC) voltage as shown in FIG. 7, so that the DC voltage is proportional to the mark-space ratio of the PWM. In such a manner, the DC voltage functions as the sampling basis of the current of the actuating circuit module 30 to decide the output constant current of the actuating circuit module 30. Thus, the dimming operation of the actuating and dimming integration circuit 3 integrates the combination of digital and analogue without the shortcomings of a conventional LED lamp which is pure digital or pure analogue, so that the LED lamp operated by the dimming operation of the actuating and dimming integration circuit 3 will not blink, is operated stably and has a high working efficiency.

Accordingly, the actuating and dimming integration circuit 3 integrates the dimming and actuating actions of the LED lamp so that the LED lamp is directly actuated and dimmed without having to provide an independent dimming system. In addition, the LED lamp is dimmed by regulation of a steady-state constant current instead of a conventional phase-cut dimming regulation. Further, the current passing through the LED lamp is regulated by changing the basis voltage of the regulating constant current circuit module 33 so as to stabilize and balance the LED lamp so that the LED lamp is worked stably in a steady manner. Further, the brightness of the LED lamp is regulated by changing the basis voltage of the regulating constant current circuit module 33 so that the brightness of the LED lamp is changed and adjusted easily and conveniently.

Especially referring to FIG. 3, the actuating and dimming integration circuit 3 further includes a first color temperature regulating module 38 connected with the main control chip 32, and a second color temperature regulating module 39 connected with the main control chip 32.

The first color temperature regulating module 38 includes a first resistor 380, a second resistor 381, a third resistor 382, a photovoltaic coupler 383, a transistor 384 and an output 385. The first resistor 380 of the first color temperature regulating module 38 is connected with a second terminal 321 of the main control chip 32. The second terminal 321 of the main control chip 32 has a PWM passing through the first resistor 380, the photovoltaic coupler 383, the second resistor 381, the third resistor 382, the transistor 384 and the output 385 of the first color temperature regulating module 38 to regulate the opening time of the output 385 of the first color temperature regulating module 38.

The second color temperature regulating module 39 includes a first resistor 390, a second resistor 391, a third resistor 392, a photovoltaic coupler 393, a transistor 394 and an output 395. The first resistor 390 of the first color temperature regulating module 39 is connected with a third terminal 322 of the main control chip 32. The third terminal 322 of the main control chip 32 has a PWM passing through the first resistor 390, the photovoltaic coupler 393, the second resistor 391, the third resistor 392, the transistor 394 and the output 395 of the second color temperature regulating module 39 to regulate the opening time of the output 395 of the second color temperature regulating module 39.

When in use, the second terminal 321 and the third terminal 322 of the main control chip 32 output complementary PWM waves so that the actuating and dimming integration circuit 3 (or the micro controller unit) can regulate the proportion of the second terminal 321 and the third terminal 322 of the main control chip 32 to change the time ratio of the output 385 of the first color temperature regulating module 38 and the output 395 of the second color temperature regulating module 39, so as to regulate an opening time of the LED lamp, and to regulate the color temperature of the LED lamp.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A ceiling fan device comprising:
a ceiling fan; and
an actuating and dimming integrator; wherein:
the ceiling fan is provided with a light emitting diode (LED) lamp;
the actuating and dimming integrator includes an actuating and dimming integration circuit;
the actuating and dimming integration circuit includes an actuating circuit module, a regulating constant current circuit module, and a main control chip connected with the actuating circuit module and the regulating constant current circuit module;
the regulating constant current circuit module includes a first photovoltaic coupler, a digital/analogue (D/A) converter circuit, a comparator chip, and a sampling resistor;
the actuating and dimming integration circuit further includes a second photovoltaic coupler connected between the actuating circuit module and the comparator chip;
the main control chip outputs a pulse width modulation (PWM) which is transmitted through the first photovoltaic coupler to the D/A converter circuit to produce a steady direct-current basis voltage which is supplied to the comparator chip to function as a standard of a current sampling judgment; and
the comparator chip samples and compares a current of the sampling resistor with the direct-current basis voltage.

2. The ceiling fan device of claim 1, wherein the actuating and dimming integrator is mounted on a bottom of the ceiling fan and connected with the LED lamp of the ceiling fan.

3. The ceiling fan device of claim 1, wherein the first photovoltaic coupler is connected with the main control chip.

4. The ceiling fan device of claim 3, wherein the main control chip has a terminal connected to the first photovoltaic coupler.

5. The ceiling fan device of claim 1, wherein the D/A converter circuit is connected with the first photovoltaic coupler.

6. The ceiling fan device of claim 1, wherein the D/A converter circuit includes a first resistor, a second resistor, a third resistor and a capacitor.

7. The ceiling fan device of claim 1, wherein the comparator chip is connected with the D/A converter circuit.

8. The ceiling fan device of claim 1, wherein the sampling resistor is connected with the comparator chip.

9. The ceiling fan device of claim 1, wherein the sampling resistor is connected with the LED lamp serially, with a current passing through the LED lamp being equal to that passing through the sampling resistor.

10. The ceiling fan device of claim 1, wherein the sampling resistor is connected with the actuating circuit module.

11. The ceiling fan device of claim 1, wherein the direct-current basis voltage is proportional to the current passing through the sampling resistor.

12. The ceiling fan device of claim 1, wherein:
the actuating and dimming integration circuit further includes:
a first color temperature regulating module connected with the main control chip; and
a second color temperature regulating module connected with the main control chip;
the first color temperature regulating module includes a first resistor, a second resistor, a third resistor, a photovoltaic coupler, a transistor and an output;
the first resistor of the first color temperature regulating module is connected with a second terminal of the main control chip;
the second terminal of the main control chip has a PWM passing through the first resistor, the photovoltaic coupler, the second resistor, the third resistor, the transistor and the output of the first color temperature regulating module to regulate the opening time of the output of the first color temperature regulating module;
the second color temperature regulating module includes a first resistor, a second resistor, a third resistor, a photovoltaic coupler, a transistor and an output;
the first resistor of the first color temperature regulating module is connected with a third terminal of the main control chip;
the third terminal of the main control chip has a PWM passing through the first resistor, the photovoltaic coupler, the second resistor, the third resistor, the transistor and the output of the second color temperature regulating module to regulate the opening time of the output of the second color temperature regulating module;
the second terminal and the third terminal of the main control chip output complementary PWM waves so that the actuating and dimming integration circuit (or the micro controller unit) can regulate the proportion of the second terminal and the third terminal of the main control chip to change the time ratio of the output of the first color temperature regulating module and the output of the second color temperature regulating module, so as to regulate an opening time of the LED lamp, and to regulate the color temperature of the LED lamp.
